(19) United States
(12) Patent Application Publication
(10) Pub. No.: US 2018/0213751 A1
(43) Pub. Date: Aug. 2, 2018

(54) POULTRY FARMING

(71) Applicant: S.A. KESHET PROJECTS LTD., MOSHAV AVIGDOR (IL)

(72) Inventors: SHLOMO BARANES, MOSHAV AVIGDOR (IL); ARIE HAHAM, GEDERA (IL)

(21) Appl. No.: 15/617,396

(22) Filed: Jun. 8, 2017

Related U.S. Application Data
(60) Provisional application No. 62/452,407, filed on Jan. 31, 2017.

(51) Int. Cl. A01K 31/18; A01K 39/02; A01K 39/014; A01K 39/01

(52) U.S. Cl. CPC A01K 31/18; A01K 39/0113; A01K 39/014; A01K 39/02

(57) ABSTRACT

The present subject matter provides: a liftable nest, configured to serve as a preferable place for birds to lay their eggs in, and facilitate harvest of the eggs, either automatically or manually; a birds feeding device, allowing feeding a flock of birds at the same time, and also allowing feeding different groups of birds, for example, males and females, in separate times, as well as with different types of food; and a poultry farming system configured to facilitate egg laying by birds and control feeding of birds. Embodiments of the liftable nest, the birds feeding device and the poultry farming system are disclosed herein.

### CROSS-REFERENCE TO RELATED APPLICATION

The present application claims priority to U.S. provisional patent application Ser. No. 62/452,407, filed Jan. 31, 2017, incorporated herein by reference.

### FIELD OF THE INVENTION

The present subject matter relates to poultry farming. More particularly, the present subject matter relates to poultry farming facilities comprising improved egg laying and feeding systems.

### BACKGROUND OF THE INVENTION

Poultry farming is the raising of domesticated birds such as chickens, ducks, turkeys and geese for the purpose of farming meat or eggs for food. Poultry are farmed in great numbers with chickens being the most numerous. Chickens are raised as a source of food, for both their meat and their eggs. Chickens raised for eggs are usually called layers while chickens raised for meat are often called broilers.

Free-range poultry farming involves raising poultry freely on the ground in an open space. The poultry may be raised indoors, for example freely in a closed facility; or outdoors, for example in a fenced area of land.

Raising free-range layers involves a challenge regarding the place where the poultry lay their eggs. There is a need for a system that comprises a place that is preferable by layers to lay their eggs in one hand, and facilitates harvest of the eggs, either automatically or manually, on the other hand.

Another challenge is related to feeding of free-range poultry. For example, there is a difference between males and females in terms of the diet they have to consume, and feeding regime during the day. Furthermore, in order to avoid stress, for example among broilers, all the birds should have access to the food at the same time. These requirements pose challenges to free-range poultry farmers.

Therefore, there is a need for a system that in one hand provides a place that is preferable by layers to lay their eggs and facilitates harvesting of the eggs, and on the other hand provides a feeding device that allows feeding a flock of birds at the same time, and also allows feeding different groups of birds, for example males and females, in separate times, as well as with different types of food.

### SUMMARY OF THE INVENTION

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided a liftable nest, comprising: a floor, a roof, at least one wall enclosing a space between the floor and the roof, at least one opening in each of the at least one wall, wherein the at least one opening is configured to allow entrance of birds into the liftable nest, and exit of birds from the liftable nest.

According to one embodiment, the liftable nest further comprising at least one leg.

According to another embodiment, the at least one leg is foldable.

According to yet another embodiment, the liftable nest further comprises at least one ramp extending beyond a wall, wherein the ramp is configured to allow birds to stand on it.

According to still another embodiment, the at least one ramp is foldable in a manner that allows changing of an angle between the ramp and the floor of the liftable nest.

According to a further embodiment, the ramp is inclined downwards and is configured to allow ascent or descent of the birds to or from the liftable nest, when the liftable nest is lifted above the ground.

According to yet a further embodiment, the liftable nest further comprises at least one drinker attached to a wall of the liftable nest.

According to still a further embodiment, the at least one drinker is attached to a wall of the liftable nest near an opening at the wall, and wherein the drinker is configured to allow a bird to drink a liquid from the drinker while sitting inside the liftable nest, and attract birds that are not in the liftable nest to get into the liftable nest.

According to another aspect of the present subject matter, there is provided a birds feeding device, comprising: a feed line configured to be filled with food and being accessed by birds to eat the food, and at least one grill assembly covering the feed line, the grill assembly comprising a fixed grill comprising multiple bars and gaps between the bars; and a movable grill assemble with the fixed grill, the movable grill comprising multiple bars and gaps between the bars, wherein access of birds to food that is in the feed line is allowed only through the gaps between the bars, wherein the movable grill is configured to move along the fixed grill, thus changing the size of the gaps between the bars of the fixed grill and the bars of the movable grill.

According to one embodiment, the bars of the fixed grill and the bars of the movable grill are vertical in relation to the feed line.

According to another embodiment, the bars of the fixed grill are parallel to the bars of the movable grill.

According to yet another embodiment, the grill assembly may be either in an open state, thus allowing access of birds to food that is in the feed line; or in a closed state, thus preventing access of birds to food that is in the feed line; or in an intermediate state, wherein the size of gaps between the bars may be un any size between the size of the gaps in the closed state and the size of the gaps in open state, thus allowing control of the type of birds that have access to food that is in the feed line, according to the size of the birds.

According to another aspect of the present subject matter, there is provided a poultry farming system configured to facilitate egg laying by birds and control feeding of birds, comprising a liftable nest and a birds feeding device.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a perspective view of a liftable nest.

FIGS. 2A-C schematically illustrate, according to an exemplary embodiment, a side view of a ramp extending beyond a wall of a liftable nest, at three different positions.

FIG. 3 schematically illustrates, according to an exemplary embodiment, a perspective view of a wall of a liftable nest, and a drinker attached to the wall.

FIG. 4 schematically illustrates a perspective view of an exemplary embodiment of a drinker.

FIG. 5 schematically illustrates, according to an exemplary embodiment, a perspective view of feeding device.

FIG. 6 schematically illustrates, according to an exemplary embodiment, a side view of a feeding device.

FIGS. 7A-B schematically illustrate, according to an exemplary embodiment, a perspective view and a side view, respectively, of a grill assembly in an open state.

FIGS. 8A-B schematically illustrate, according to an exemplary embodiment, a perspective view and a side view, respectively, of a grill assembly in an open state, when the movable grill is devoid of a hold element.

FIGS. 8A-B schematically illustrate, according to an exemplary embodiment, a perspective view and a side view, respectively, of a grill assembly in an open state, when the movable grill is devoid of a hold element.

FIG. 9A schematically illustrates, according to an exemplary embodiment, a side view of a grill assembly in an open state, when the movable grill comprises a hold element, and the height of the movable grill is shorter than the height of the fixed grill.

FIG. 9B schematically illustrates, according to an exemplary embodiment, a side view of a grill assembly in a closed state, when the movable grill comprises a hold element, and the height of the movable grill is shorter than the height of the fixed grill.

FIGS. 10A-B schematically illustrate, according to an exemplary embodiment, a perspective close up view of a first end and a second end, respectively, of a grill assembly, in an open state.

FIG. 11 schematically illustrates, according to an exemplary embodiment, an upper close up view of a first grill assembly attached to a second grill assembly.

FIG. 12A schematically illustrates, according to an exemplary embodiment, a perspective close-up view of a first connector at a first end of a grill assembly.

FIG. 12B schematically illustrates, according to an exemplary embodiment, a perspective close-up view of a second connector and a second end of a grill assembly.

FIGS. 13A-B schematically illustrate, according to an exemplary embodiment, a perspective close-up view and an upper close-up view, respectively, of a first connector of a first grill assembly connected to a second connector of a second grill assembly.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

The present subject matter provides a poultry farming system 1, configured to facilitate egg laying by birds and control feeding of the birds. According to one aspect, the system 1 comprises a liftable nest 10 and a feeding device 20.

According to one embodiment, the liftable nest 10 is configured to serve as a preferable place for birds to lay their eggs in, and facilitate harvest of the eggs, either automatically or manually. The term “nest”, as disclosed herein, refers to a housing configured to be a place where birds lay their eggs.

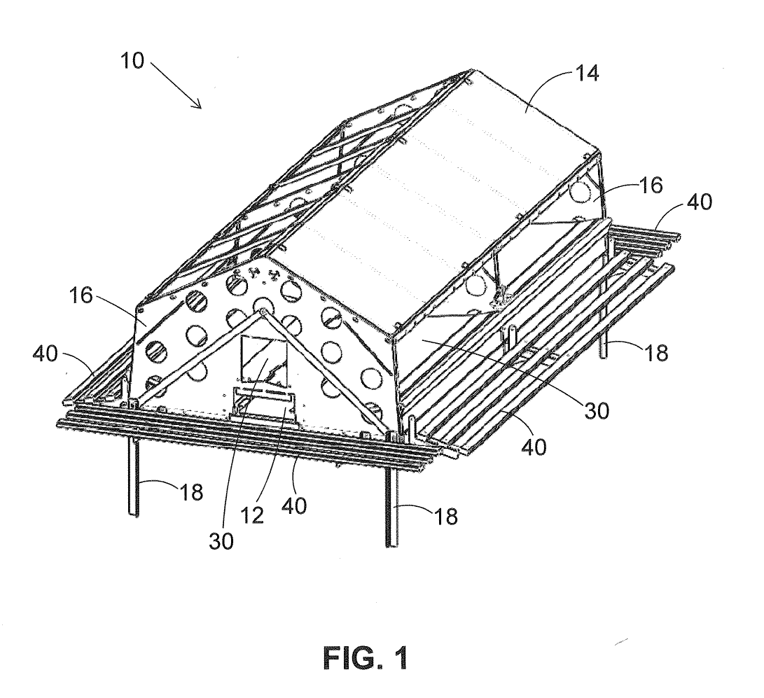

FIG. 1 schematically illustrates, according to an exemplary embodiment, a perspective view of a liftable nest 10, namely the nest is configured to be lifted above the ground. The liftable nest 10 comprises a floor 12, a roof 14, and at least one wall 16 enclosing a space between the floor 12 and roof 14. According to the embodiment illustrated in FIG. 1, the liftable nest 10 comprises four walls 16.

According to one embodiment, the liftable nest 10 may be standing on the ground in a manner that the floor 12 of the liftable nest 10 rests directly on the ground. According to another embodiment, the liftable nest 10 may be lifted above the ground in a manner that the floor 12 of the liftable nest 10 is above the ground. This may be achieved, for example, by using a lifting mechanism comprising cables that are attached to the nest 10 (not shown). Alternatively, the liftable nest 10 may be lifted manually. The liftable nest 10 may be lifted above the ground to any desired height. According to a preferred embodiment, the liftable nest 10 is lifted to a height of substantially 60 cm between the floor 12 of the liftable nest 10 and the ground.

According to a further embodiment, the liftable nest 10 comprises at least one leg 18. According to a preferred embodiment, the at least one leg 18 is foldable. Thus, when the liftable nest 10 is positioned on the ground, the at least one leg 18 is folded. When the liftable nest 10 is lifted, the at least one leg 18 is unfolded, and is used to support the liftable nest 10 in a manner that keeps the floor 12 of the liftable nest 10 above the ground while the at least one leg 18 stands on the ground. According to a preferred embodiment, the at least one leg 18 is in a length of substantially 60 cm, thus allowing standing of the liftable nest 10 while the floor 12 of the liftable nest 10 is substantially 60 cm above the ground.

According to an additional embodiment, the liftable nest 10 is configured to let entrance of birds through all sides of the liftable nest 10. According to one embodiment, the liftable nest 10 comprises at least one opening 30 in each wall, the at least one opening 30 is configured to allow entrance of birds into the liftable nest 10 and exit of birds from the liftable nest 10. According to the exemplary embodiment illustrated in FIG. 1, the liftable nest 10 comprises four walls 16, and in each of the four walls 16 there is an opening 30.

According to one embodiment, the liftable nest 10 comprises at least one ramp 40 extending beyond a wall 16 of the nest 10. According to another embodiment, the at least one ramp 40 is attached to the wall 16 at the level of the floor 12 of the liftable nest 10. According to a preferred embodiment, the liftable nest 10 comprises a ramp 40 at each side of the liftable nest 10. Thus, according to the exemplary embodiment illustrated in FIG. 1, when the liftable nest 10 comprises four walls 16 and an opening 30 at each wall, the liftable nest 10 further comprises at least one ramp 40 attached to each wall 16. The ramp 40 is configured to allow birds to stand on it, for example while entering or exiting the liftable nest 10. According to a preferred embodiment, the ramp 40 facilitates entry of birds into the liftable nest 10 and exit of birds from the liftable nest 10 when the liftable nest 10 is lifted.

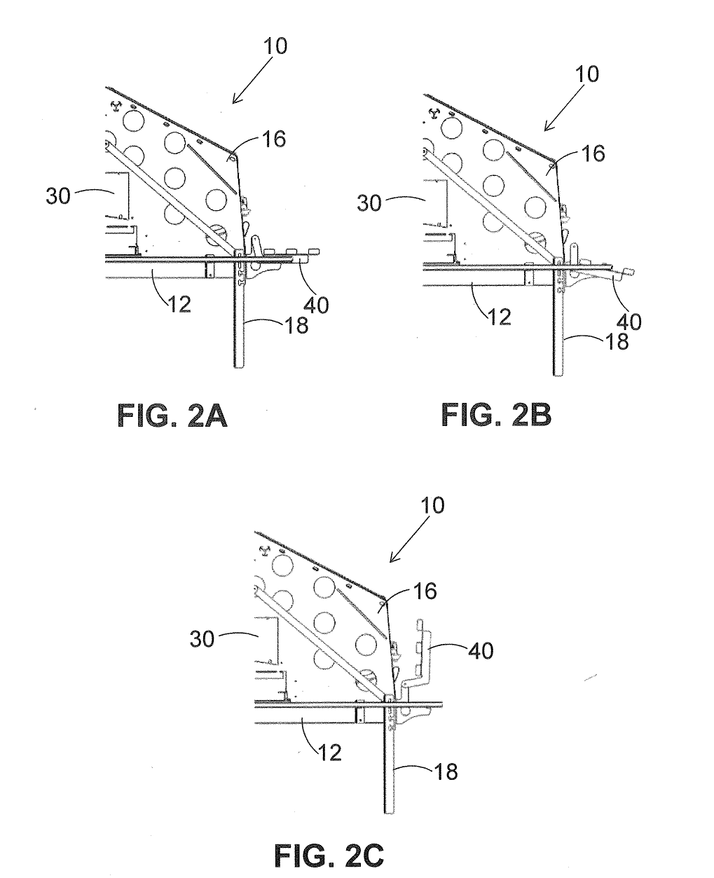

FIGS. 2A-C schematically illustrate, according to an exemplary embodiment, a side view of a ramp 40 extending beyond a wall 16 of a liftable nest 10, at three different positions. According to one embodiment, the ramp 40 is foldable in a manner that allows changing of an angle between the ramp 40 and the floor 12 of the liftable nest 10.

FIG. 2A illustrates a ramp 40 that is horizontally positioned, namely the angle between the ramp 40 and the floor 12 of the liftable nest 10 is substantially 180°. A ramp 40 at a horizontal position allows standing of birds on the ramp 40.

FIG. 2B illustrates a ramp 40 that is folded in a manner that the angle between the ramp 40 and the floor 12 of the liftable nest 10 is greater than 180°. In other words, the ramp 40 is inclined downwards towards the ground. This allows ascent or descent of birds to or from the liftable nest 10, when the liftable nest 10 is lifted above the ground. This is especially important when a bird wishes to descent from a lifted liftable nest 10. If the floor 12 of the liftable nest 10 is substantially 60 cm above ground, a bird jumping from the floor 12 to the ground may be injured. However, using a ramp 40 inclined downwards decreases the height from which the bird jumps down, thus decreasing the chance for the bird to get injured. Furthermore, the degree of incline of the ramp 40 downwards may be changed according to the age and/or size of the birds. For example, for young birds, that can jump from a high position, the ramp 40 is inclined downwards in a lesser degree, allowing the young birds to jump to the ground from a high position. On the other hand, for older birds, that should jump from a relatively low position, in order to avoid injury, the ramp 40 is inclined downwards to a higher degree, allowing the older bird to jump to the ground from a low position.

FIG. 2C illustrates a ramp 40 that is folded in a manner that the angle between the ramp 40 and the floor 12 of the liftable nest 10 is less than 180°. In other words, the ramp 40 in inclined upwards towards the wall 16 of the liftable nest 10. This allows for example blockage of an opening 30 of the liftable nest 10, as desired.

According to another embodiment, the liftable nest 10 further comprises at least one drinker 50.

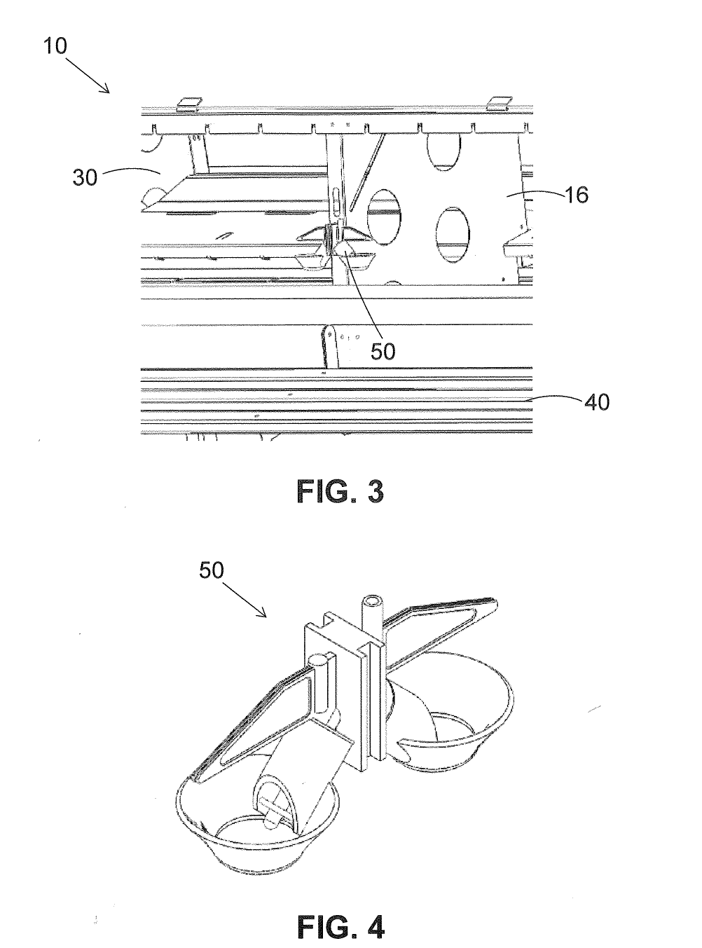

FIG. 3 schematically illustrates, according to an exemplary embodiment, a perspective view of a wall 16 of a liftable nest 10, and a drinker 50 attached to the wall 16.

FIG. 4 schematically illustrates a perspective view of an exemplary embodiment of a drinker 50.

According to one embodiment, the at least one drinker 50 is configured to supply a drinking liquid, for example water, to the birds. According to another embodiment, the drinker 50 further comprises a tubing configured to transfer a drinking liquid to the drinker 50. Any type of drinker 50 known in the art is under the scope of the present subject matter, for example, but not limited to, a poultry drinker manufactured for example by PLASSON, Maagan Michael, Israel; a nipple drinker manufactured for example by PLASSON, Maagan Michael, Israel, or LUBING Maschinenfabrik GmbH & Co. KG, Barnstorf, Germany, and the like.

According to a further embodiment, the drinker 50 is attached to a wall 16 of a liftable nest 10 near an opening 30 at the wall 16. This allows a bird to drink a liquid from the drinker 50 while sitting inside the liftable nest 10, without being needed to leave the liftable nest 10 to drink from drinkers installed in other places in the poultry farming facility. Furthermore, the drinker 50 attracts birds that are not in the liftable nest 10 to get into the liftable nest 10 in order to drink. This feature increases the chance that birds would prefer to lay their eggs in the liftable nest 10, by increasing the chance that a bird that is already in the liftable nest 10 would not leave the liftable nest 10 to drink in other places, and by increasing the chance that a bird that is not in the liftable nest 10 would get into the liftable nest 10. In other words, a benefit of including a drinker 50 in the liftable nest 10 is that it facilitates acclimation of birds to stay in the liftable nest 10, thus encouraging in the birds the habit of laying eggs in the liftable nest 10 instead of in other places.

The present subject matter further provides a birds feeding device 20 that is configured to allow feeding a flock of birds at the same time, and also allows feeding different groups of birds, for example males and females, or birds in different age groups, in separate times, as well as with different types of food. For the sake of simplicity only, the birds feeding device 20 is occasionally designated hereinafter “feeding device 20”.

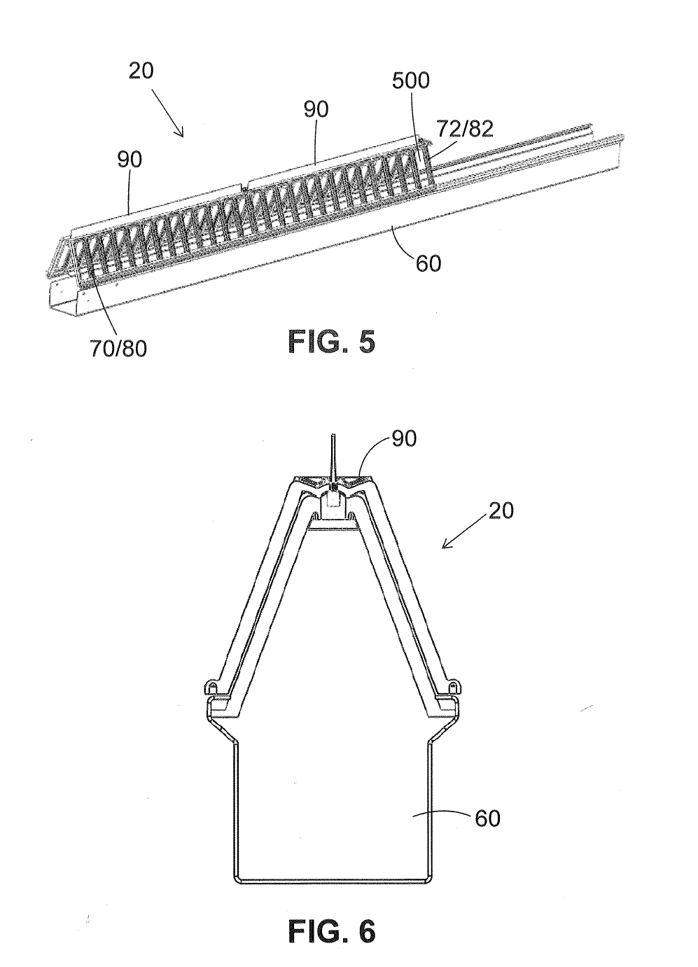

FIG. 5 schematically illustrates, according to an exemplary embodiment, a perspective view of feeding device 20.

FIG. 6 schematically illustrates, according to an exemplary embodiment, a side view of a feeding device 20.

According to one embodiment, the feeding device 20 comprises a feed line 60, configured to be filled with food and being accessed by birds to eat the food; and at least one grill assembly 90 covering the feed line 60. The grill assembly 90 comprises a fixed grill 70 comprising multiple bars 72 and gaps 500 between the bars 72; and a movable grill 80 assembled with the fixed grill 70, the movable grill 80 comprising multiple bars 82 and gaps 500 between the bars 82. Thus, access of birds to food that is in the feed line 60 is allowed only through the gaps 500 between the bars 72 of the fixed grill 70 and the bars 82 of the movable grill 80. According to one embodiment, the bars 72 of the fixed grill 70 and the bars 82 of the movable grill 80 are vertical in relation to the feed line 60, as illustrated for example in FIG. 6. According to another embodiment, the orientation of the bars 72 of the fixed grill 70 and the bars 82 of the movable grill 80, relative to the feed line 60, is any orientation that allows access of birds to food that is in the feed line 60 through the gaps 500 in between the bars 72 and 82. According to a further embodiment, the bars 72 of the fixed grill 70 are parallel to the bars 82 of the movable gear 80, as illustrated for example in FIG. 6. According to yet a further embodiment, the bars 72 of the fixed grill 70 are not parallel to the bars 82 of the movable grill 80. The movable grill 80 is configured to move along the fixed grill 70, for example by sliding along or aside the fixed grill 70, thus changing the size of gaps 500 between the bars 72 of the fixed grill 70 and the bars 82 of the movable grill 80. Thus, changing the size of the gaps 500 between the bars 72 and 82 allows control of the access of birds to the food filled in the feed line 60.

According to a further embodiment, the grill assembly 90 covers an entire feed line 60 (Not shown). According to yet a further embodiment, the grill assembly 90 covers a part of the feed line 60, as illustrated in FIG. 5. Thus, at least one grill assembly 90 covers the feed line 60.

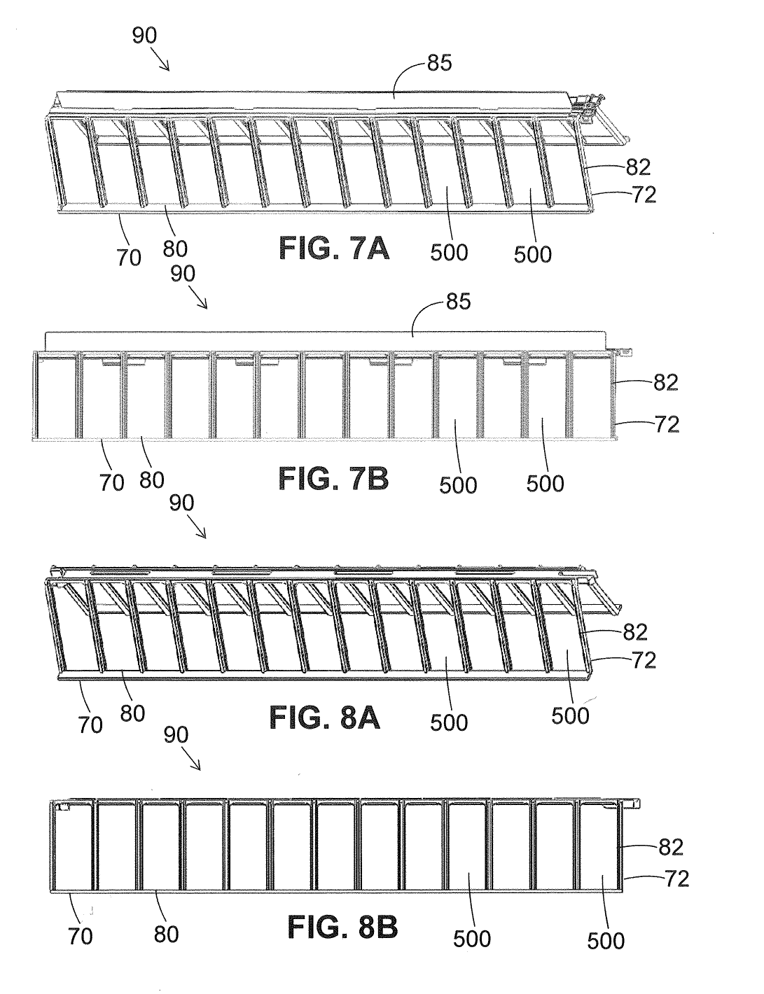

FIGS. 7A-B schematically illustrate, according to an exemplary embodiment, a perspective view and a side view, respectively, of a grill assembly 90 in an open state.

According to the embodiment illustrated in FIG. 7A-B, the bars 82 of the movable grill 80 overlap with the bars 72 of the fixed grill 70. Thus, the gaps 500 between the bars 72 and 82 are maximal in size, allowing access of birds to food that is in the feed line 60. According to the embodiment illustrated in FIGS. 7A-B, the movable grill 80 comprises a hold element 85, configured to be held by a user and facilitate movement of the movable grill 80 by the user.

FIGS. 8A-B schematically illustrate, according to an exemplary embodiment, a perspective view and a side view, respectively, of a grill assembly 90 in an open state, when the movable grill 80 is devoid of a hold element 85. According to this embodiment, the movable grill 80 may be moved, for example, by holding a bar 82 of the movable grill 80 and moving it along the fixed grill 70. All the other embodiments of the grill assembly 90 illustrated in FIGS. 8A-B are similar to the embodiments illustrated in FIGS. 7A-B.

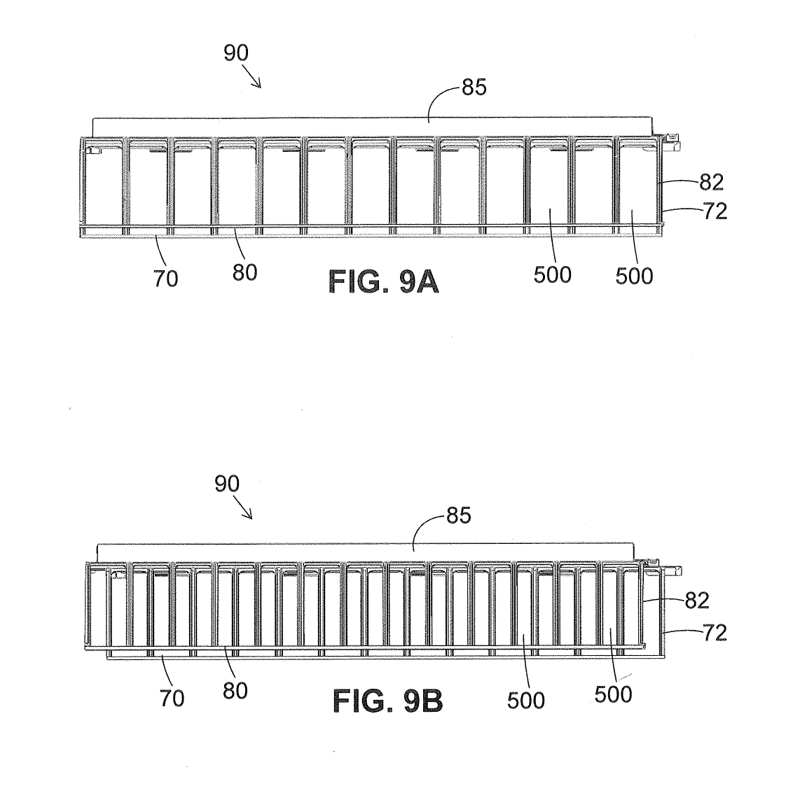

FIG. 9A schematically illustrates, according to an exemplary embodiment, a side view of a grill assembly 90 in an open state, when the movable grill 80 comprises a hold element 85, and the height of the movable grill 80 is shorter than the height of the fixed grill 70. According to this embodiment, the height of the movable grill 80 is not similar to the height of the fixed grill 70.

FIG. 9B schematically illustrates, according to an exemplary embodiment, a side view of a grill assembly 90 in a closed state, when the movable grill 80 comprises a hold element 85, and the height of the movable grill 80 is shorter than the height of the fixed grill 70. According to the embodiment illustrated in FIG. 9B of the grill assembly 90 in a closed state, the bars 82 of the movable grill 80 are positioned in the middle of the gaps 500 between the bars 72 of the fixed grill 70, thus preventing access of birds to food that is in the feed line 60, because the gaps 500 are small and do not allow access of birds to the feed line 60. According to another embodiment, the grill assembly 90 may be in an intermediate state when the bars 82 of the movable grill 80 may be positioned in any intermediate position between the open state illustrated in FIG. 7A and the closed state illustrated in FIG. 7B. In the intermediate state, the size of gaps 500 between the bars 72 and 82 may be in any size between the size of the gaps 500 in the closed state and the size of the gaps 500 in the open state, thus allowing control of the type of birds that have access to food that is in the feed line 60, according to the size of the birds. In an embodiment according to which more than one grill assembly 90 covers a feed line 60, as illustrated in FIG. 5, each grill assembly may be in state that allows access of a different type of the birds to the feeding line. For example, a first grill assembly 90 may be in an open state with small gaps 500 between the bars 72 and 82, thus allowing access of only small birds, for example young birds, to the feed line 60; and a second grill assembly 90 may be in an open state with bigger gaps 500 between the bars 72 and 82, thus allowing access of bigger birds, for example old birds, to the feed line 60.

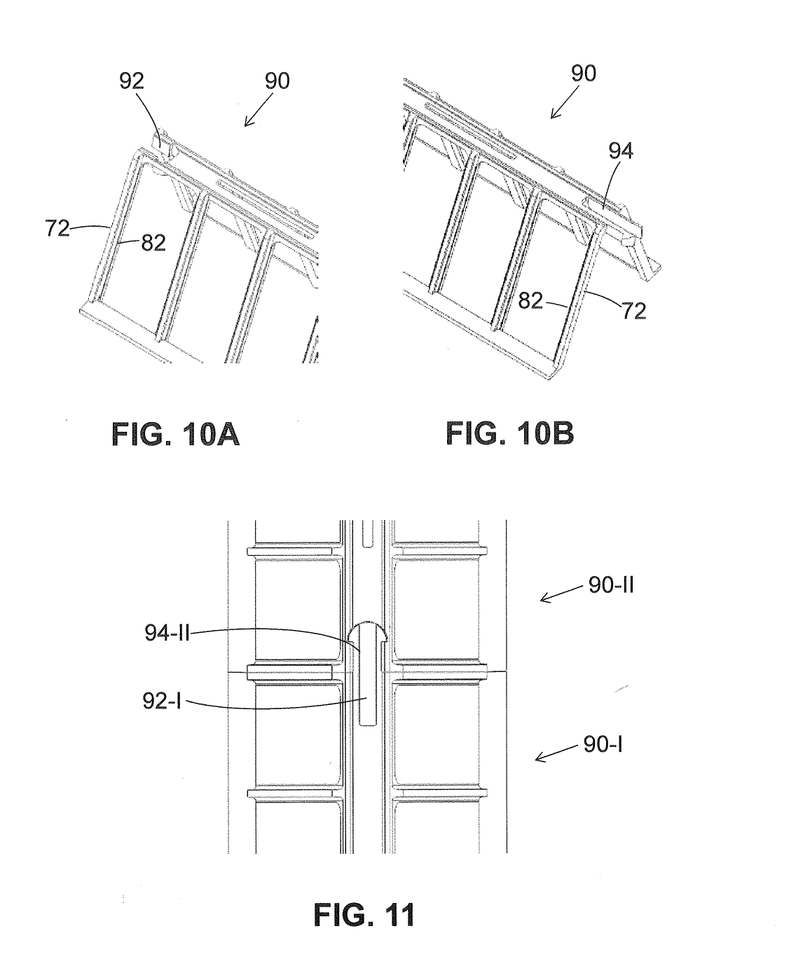

FIGS. 10A-B schematically illustrate, according to an exemplary embodiment, a perspective close up view of a first end 92 and a second end 94, respectively, of a grill assembly 90, in an open state. According to one embodiment, the grill assembly 90 comprises a first end 92 and a second end 94.

FIG. 11 schematically illustrates, according to an exemplary embodiment, an upper close up view of a first grill assembly 90-I attached to a second grill assembly 90-II. According to one embodiment, a first end 92-I of the first grill assembly 90-I is configured to be attached to a second end 94-II of a second grill assembly 90-II, in a manner that maintains the first grill assembly 90-I and the second grill assembly 90-II attached one to the other.

According to one embodiment, a grill assembly 90 may comprise a connector at each one of its ends.

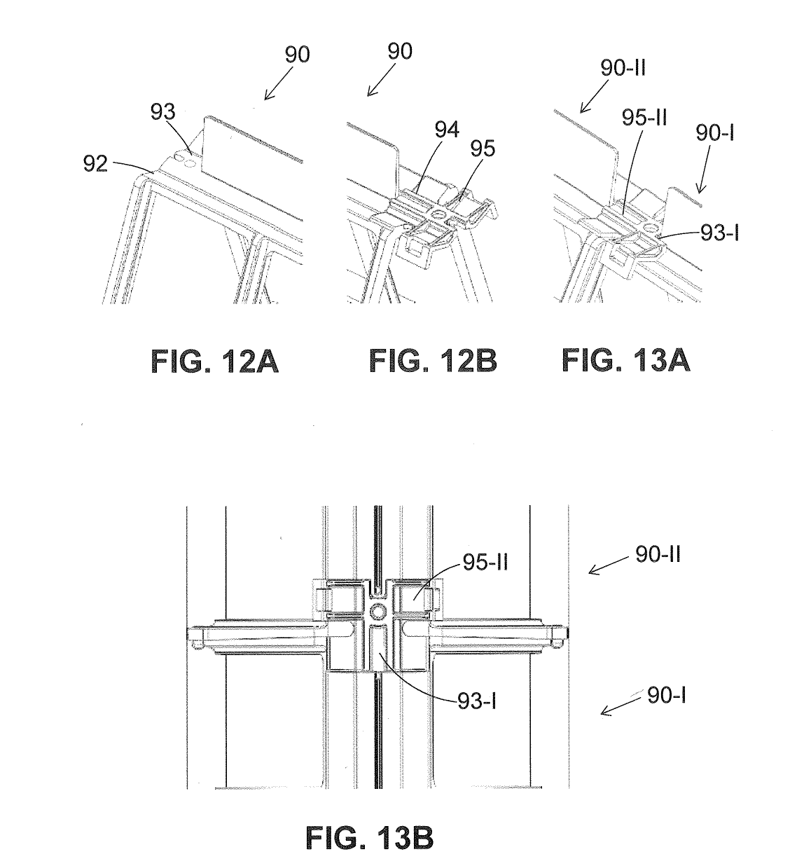

FIG. 12A schematically illustrates, according to an exemplary embodiment, a perspective close-up view of a first connector 93 at a first end 92 of a grill assembly 90.

FIG. 12B schematically illustrates, according to an exemplary embodiment, a perspective close-up view of a second connector 95 and a second end 94 of a grill assembly 90.

FIGS. 13A-B schematically illustrate, according to an exemplary embodiment, a perspective close-up view and an upper close-up view, respectively, of a first connector 93-I of a first grill assembly 90-I connected to a second connector 95-II of a second grill assembly 90-II.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A liftable nest, comprising: a floor, a roof, at least one wall enclosing a space between the floor and the roof, at least one opening in at least one of the at least one wall, wherein the at least one opening is configured to allow entrance of birds into the nest, and exit of birds from the nest.

2. The liftable nest of claim 1, further comprising at least one leg.

3. The liftable nest of claim 2, wherein the at least one leg is foldable.

4. The liftable nest of claim 1, further comprising at least one ramp extending beyond a wall, wherein the ramp is configured to allow birds to stand on it.

5. The liftable nest of claim 4, wherein the at least one ramp is foldable in a manner that allows changing of an angle between the ramp and the floor of the nest.

6. The liftable nest of claim 5, wherein the ramp is inclined downwards and is configured to allow ascent or descent of the birds to or from the nest, when the nest is lifted above the ground.

7. The liftable nest of claim 1, further comprising at least one drinker attached to a wall of the nest.

8. The liftable nest of claim 7, wherein the at least one drinker is attached to a wall of the nest near an opening at the wall, and wherein the drinker is configured to allow a bird to drink a liquid from the drinker while sitting inside the nest, and attract birds that are not in the liftable nest to get into the liftable nest.

9. A birds feeding device, comprising: a feed line configured to be filled with food and being accessed by birds to eat the food, and at least one grill assembly covering the feed line, the grill assembly comprising a fixed grill comprising multiple bars and gaps between the bars; and a movable grill assemble with the fixed grill, the movable grill comprising multiple bars and gaps between the bars, wherein access of birds to food that is in the feed line is allowed only through the gaps between the bars, wherein the movable grill is configured to move along the fixed grill, thus changing the size of the gaps between the bars of the fixed grill and the bars of the movable grill.

10. The birds feeding device of claim 9, wherein the bars of the fixed grill and the bars of the movable grill are vertical in relation to the feed line.

11. The birds feeding device of claim 9, wherein the bars of the fixed grill are parallel to the bars of the movable grill.

12. The birds feeding device of claim 9, wherein the grill assembly may be either in an open state, thus allowing access of birds to food that is in the feed line; or in a closed state, thus preventing access of birds to food that is in the feed line; or in an intermediate state, wherein the size of gaps between the bars may be un any size between the size of the gaps in the closed state and the size of the gaps in open state, thus allowing control of the type of birds that have access to food that is in the feed line, according to the size of the birds.

13. A poultry farming system configured to facilitate egg laying by birds and control feeding of birds, comprising:
a liftable nest comprising: a floor, a roof, at least one wall enclosing a space between the floor and the roof, at least one opening in at least one of the at least one wall, wherein the at least one opening is configured to allow entrance of birds into the nest, and exit of birds from the nest; and
a birds feeding device comprising: a feed line configured to be filled with food and being accessed by birds to eat the food, and at least one grill assembly covering the feed line, the grill assembly comprising a fixed grill comprising multiple bars and gaps between the bars; and a movable grill assemble with the fixed grill, the movable grill comprising multiple bars and gaps between the bars, wherein access of birds to food that is in the feed line is allowed only through the gaps between the bars, wherein the movable grill is configured to move along the fixed grill, thus changing the size of the gaps between the bars of the fixed grill and the bars of the movable grill.
